(19) United States
(12) Patent Application Publication
(10) Pub. No.: US 2011/0259920 A1
(43) Pub. Date: Oct. 27, 2011

(54) LIQUID DISPENER WITH CONCEALED REFILL OPENING

(75) Inventors: Patrick Rennie, Morris Township, NJ (US); Philippe de Brugiere, Marly-le-Roi (FR)

(73) Assignee: L'OCCITANE, Manosque en Provence (FR)

(21) Appl. No.: 12/992,526

(22) PCT Filed: May 13, 2009
(86) PCT No.: PCT/EP09/55785

§ 371 Date: Jun. 28, 2011

(30) Foreign Application Priority Data
May 13, 2008 (FR) 08/02595

(51) Int. Cl. A47K 5/12; B67D 7/84

(52) U.S. Cl. 222/165; 222/180

(57) ABSTRACT

A manually operated liquid dispenser having a dispensing position and a refilling position, comprising:
a liquid container including
   a dispensing opening through which the liquid is discharged from the container in the dispensing position of the dispenser
and
   a refill opening, separate from the dispensing opening, through which the liquid is introduced in the refilling position of the dispenser and
a supporting structure which supports the liquid container in such a way as to conceal the refill opening in the dispensing position and to uncover the refill opening in the refilling position,
the supporting structure of container adapted to invert the container, and to hold the container upright in the dispensing position and inverted in the refilling position.

### PRIORITY CLAIM

The present application is a National Phase entry of PCT Application No. PCT/FR2009/055785, filed May 13, 2009, which claims priority from French Application No. 0802595, filed May 13, 2008, the disclosures of which are hereby incorporated by reference herein in their entirety.

### TECHNICAL FIELD

The invention relates to the field of liquid dispensers, such as soap dispensers, shampoo dispensers and other toiletry and cosmetics dispensers that can be found in bathrooms. As used herein, a liquid is any substance that is neither solid nor gaseous. Thus, a viscous gel or paste will be considered as liquids.

### BACKGROUND ART

Liquid dispensers, fixed vertically to a wall, comprise a container in which liquid is stored. A pump is typically inserted in the container by a liquid dispensing opening provided in the container. A push button, connected to the pump is activated from top to bottom, in order to aspirate the liquid stored in the container towards an opening provided in the push button.

The main advantage of this type of dispenser is simplicity of use. Thus, when it is mounted in a bathroom, users may use the dispenser intuitively without requiring a user guide. In hotels, this is even more advantageous as they are usually frequented by a foreign clientele, unfamiliar with the local language and thus liable to not understand dispenser user guide.

However, one of the main drawbacks of this type of dispenser is that it is liable to dirty the area around the dispenser when the dispenser container needs to be refilled/replaced. In fact, in order to refill the container, it is usually necessary to remove the pump body which is immersed in the container, in order to fill the container through the passage opening of pump body, i.e., by the container dispensing opening.

The pump body is covered in liquid, which under the effect of gravity, tends to drip and dirty the dispenser area, especially the floor, the wall whereon the dispenser is mounted and the dispenser itself. Such a dispenser further exhibits definite esthetic drawbacks which are not compatible with luxury hotel requirements. Such a dispenser leads to significant cleaning time for the chambermaids and as a result, an additional cost for the hotel manager.

Such dispensers are usually mounted in the vicinity of the control levers of a shower or bathtub. By way of example, for a bathtub, during the refilling of the dispenser container, it is essential to get in the bathtub in order to be able to handle the pump body and carry out the refilling, the bathtub thus having to be cleaned.

In order to avoid getting in the bathtub, one may handle the dispenser at arm's length, thus leading to handling difficulties of the container and thus, increasing the chance of dirtying.

Another drawback resides in the fact that the client may easily introduce a foreign substance in the container. For example, a client may, without difficulty, remove the pump body and introduce water into the container and thus dilute the dispensing liquid. The container thus contains a dispensing liquid of very poor quality that will be dispensed to future clients. The latter will be, rightly, unsatisfied, and this will undermine the brand image of the company which commercializes the dispensing liquid.

### SUMMARY OF THE INVENTION

In order to eliminate these drawbacks, the applicant proposes a manually operated liquid dispenser that can occupy a dispensing position and a refilling position comprising
a liquid container including
   A dispensing opening through which the liquid is discharged from the container in the dispensing position of the dispenser and
   A refill opening, separate from the dispensing opening, through which the liquid is introduced in the refilling position of the dispenser and
a supporting structure which supports the liquid container in such a way as to conceal the refill opening in the dispensing position and to uncover the refill opening in the refilling position
the supporting structure which supports the container adapted to invert the container and to hold the container upright in the dispensing position and inverted in the refilling position.

A dispenser according to embodiments of the invention advantageously contributes to keeping a clean outer aspect. During the refilling of the container through its refill opening, separate from its dispensing opening, if drops of liquid fall in the vicinity of the refill opening, they will not be visible since the refill opening is concealed by the supporting structure which supports the container.

Furthermore, a user will not be tempted to introduce a foreign substance into the container since the refill opening is concealed by the supporting structure which supports the container.

The supporting structure maintains the container in stable dispensing and refilling positions. During refilling, the user may use his/her two hands to handle the refill, the structure maintaining the container inverted.

The dispensing opening and the refill opening are provided at two opposing ends of the liquid container. The user may easily access the various openings from the top of the dispenser depending on whether it is upright or inverted.

According to a particular characteristic of embodiments of the invention, the supporting structure comprises a support seat, intended to be maintained fixedly, and a housing wherein the liquid container is received, the housing being rotatably mounted with respect to the support seat.

The supporting structure collaborates with the housing to invert the container between its dispensing and refilling positions.

The support seat can include a mechanism for attaching the dispenser to a wall.

The support seat, fixed to a wall, can be arranged to keep away the housing of the container away from the wall. Thus, the user may easily handle the container, which gets closer during its refilling. For a bathtub dispenser, the user does not have to get in the bathtub or to handle the container at arm's length.

According to a particular characteristic of an embodiment of the invention, the housing of the liquid container can comprise a concealing base of the refill opening.

The liquid container can comprise a refilling nozzle which is introduced into an opening provided in the concealing base. The refilling nozzle extends into the base thus stabilizing the container while concealing the refill opening from the user's sight.

The dispenser can comprise a locking plate arranged to lock/unlock the position of the housing with respect to the support seat.

The locking plate inhibits a non authorized user from accessing the refill opening. The locking plate can include an unlocking lever, which is concealed from the sight of a non authorized user, enabling the release of the housing from the support seat container.

According to a particular characteristic of embodiments of the invention, a supporting cap, arranged to maintain the container in the refilling position, is provided at the upper portion of the housing, the concealing base being provided in the lower portion of the container housing.

The supporting cap is further arranged to prevent the disassembling of a pump or another dispensing means which would be introduced into the dispensing opening, the supporting cap thus helping to protect access to the liquid in the container. Thanks to the cap and to the base, the container body is visible to the user who may see the product name inscribed on the container or the product itself if the container is transparent.

### BRIEF DESCRIPTION OF THE DRAWINGS

The invention will be better understood with the help of the accompanying drawings in which:

FIG. 1 is a left cross sectional view of a liquid dispenser according to an embodiment of the invention in locked dispensing position;

FIG. 2 is a left cross sectional view of the liquid dispenser of FIG. 1 in unlocked dispensing position;

FIG. 3 is a left cross sectional view of the liquid dispenser of FIG. 2 in turn over position;

FIG. 4 is a left cross sectional view of the liquid dispenser of FIG. 2 in refilling position;

FIG. 5 is a front view of a second embodiment of the liquid dispenser;

FIG. 6 is a right view of the liquid dispenser of FIG. 5;

FIG. 7 is a rear view of the liquid dispenser of FIG. 5;

FIG. 8 is a right cross sectional view of the liquid dispenser of FIG. 5;

FIG. 9 is an exploded view of the liquid dispenser of FIG. 5 without its container;

### DETAILED DESCRIPTION OF THE DRAWINGS

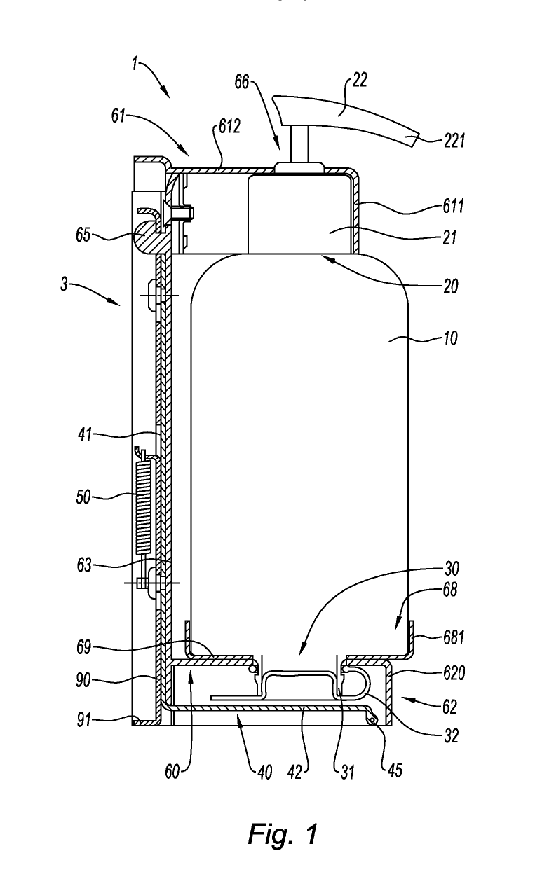

With reference to FIG. 1, a liquid dispenser 1 according to an embodiment of the invention, the liquid dispenser 1 comprises a cylindrically-shaped liquid container 10 whereof the upper side is rounded and whereof the lower side is flat.

As is standard, in the present application, the terms “higher” and “lower” are defined with respect to the drawing of FIG. 1, as well as the terms “front”, “rear”, “left” and “right”. In other words, FIG. 1 is a left view of a dispenser which is fixed from the rear and whereof the dispensing is carried out from the front.

The liquid dispenser 10 comprises, in its upper portion, a cylindrically-shaped liquid dispensing nozzle (not shown), protruding upwards, wherein is mounted a dispensing pump 21 forming a manually operated dispenser actuator. The passage section of the dispensing nozzle corresponds to the dispensing opening 20 of the container 10.

The dispensing pump 21 comprises a plunger (not shown), that is inserted in the liquid container 10 by the dispensing nozzle, and a push button 22, connected to the plunger, mounted on the outside of the container 10. The dispensing pump 21 is sealingly mounted with the dispensing nozzle. The push button 22 comprises a dispensing opening 221 whereby the container 10 liquid is dispensed.

The liquid container 10 comprises a refilling nozzle 31 that is provided on the lower side of the container 10. The refilling nozzle 31 is of cylindrical shape, protruding downwards, its passage section corresponding to the refill opening 30 of the container 10. The refilling nozzle 31 is closed by a removable cap 32, here in elastomer. The container 10 is in this example made of plastic, but other materials, such as glass or metal, would also be suitable.

The container 10 of the dispenser 1 is maintained by a supporting structure 3 comprising a housing 60 of the container 10 and a support seat 40, the housing 60 being movably mounted with respect to the support seat 40. The supporting structure is here made from plastic but could made from another material, such as metal.

The support seat 40 is exhibited in the shape of a bent plate comprising a first vertical portion 41 of rectangular shape, and a second horizontal portion 42 of rectangular shape, having a forwardly protruding free end. In other words, the support seat 40 is substantially exhibited in the shape of an L. The vertical portion 41 of the support seat 40 is here fixed to a wall by screws, other fasteners would also be suitable.

The housing 60 comprises a vertical bottom plate 63 of substantially rectangular shape. The housing 60, that is removeably fixed to the vertical portion 41 of the support seat 40 comprises, on its upper portion, a supporting cap 61 of the container and, on its lower portion, a concealing base 62 of the container 10 refill opening 30.

In this example, the supporting cap 61 is removeably fixed to the upper portion of the bottom plate 63. It could also be fixed securely.

With reference to FIG. 1, the supporting cap 61 is horizontal, i.e., it extends orthogonally to the bottom plate 63. The cap 63 is exhibited in the shape of a rectangular lid having two lateral sides (a right side and a left side), a front side 611, a rear side, a closed upper side 612 and an open lower side. The rear side of the cap 61 is fixed to the front side of the bottom plate 63. The rear side of the cap 61 comprises, in this example, fixing hooks 65 protruding backwards, forming fixing means of the cap 61, which are inserted in openings formed in the bottom plate 63.

According to a non-represented embodiment, the rear side of the cap 61 is open and the fixing hooks 65 are provided in the extension of the lateral sides of the cap 61, the fixing hooks 65, protruding backwards, being inserted in the openings formed in the bottom plate 63.

With reference to FIG. 1, the hooks 65 cross through openings formed in the vertical portion 41 of the support seat 40, to block the position of the housing 60 with respect to the support seat 40 as well as openings formed in a locking plate 90 which extends vertically parallel to the vertical portion 41 of the support seat 40.

The locking plate 90 is arranged to block or release the housing 60 of the container 10 with respect to the support seat 40. The locking plate 90 is connected to the support seat 40 by vertical springs 51 whereof the spring constant stresses the locking plate 90 to move vertically downwards in a locking position of the housing 60, the locking plate 90 thus partially obstructing the openings formed in the support seat 40.

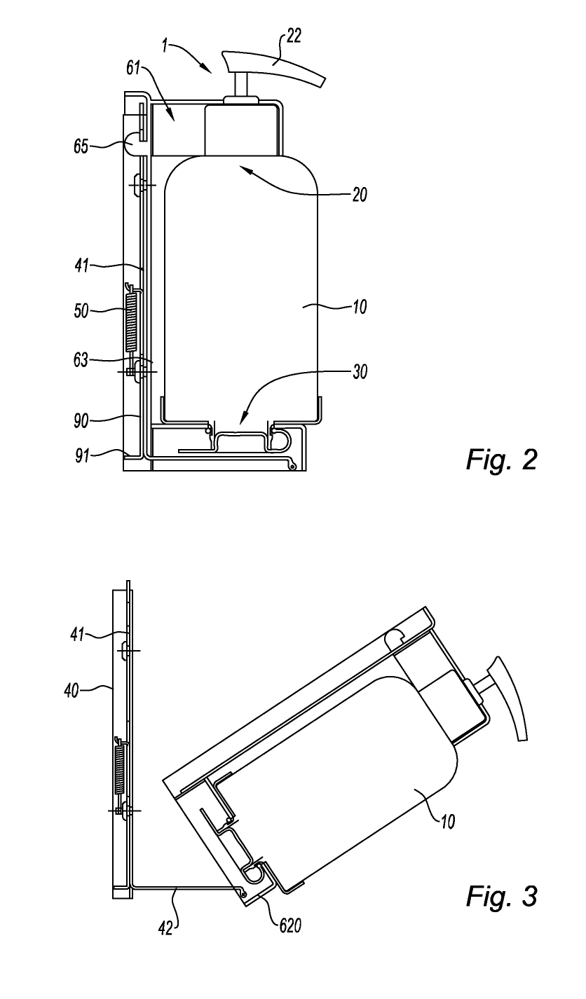

The locking plate 90 comprises, at its lower end, an unlocking lever 91, which enables a user to move the locking plate upwards (by opposing the force of the spring 51) in order to uncover the openings provided in the vertical portion 41 of the seat support 40. The housing 60 is thus unlocked as depicted in FIG. 2.

A longitudinal groove 66 is formed in the upper side 612 of the cap 61 from its rear edge to its front edge. The lateral dimension of the groove 66 of the upper side 612 is adapted to enable the passage of the push button 22 of the pump 21 through the upper side 612 of the cap 61. In a non represented embodiment, the cap 61 comprises a circular opening receiving the push button 22 of the pump 21. The cap 61 inhibits the disassembling of the pump 21.

The concealing base 62 of the refill opening 30 of the container is presented, in the form of a horizontal plate 69, fixed securely, by its rear edge to the bottom plate 63, the said horizontal plate 65 comprising a circumferential skirt 620 extending downwardly. In other words, the base 62 is presented in the form of a rectangular lid whereof the upper side corresponds to the horizontal plate 69 and whereof the rear side, the lateral sides (left and right) and the front side 612 of the lid correspond to the circumferential skirt 620. With reference to FIG. 1, the rear side of the lid, whereof the base 62 has its shape, is closed by the bottom plate 63.

The concealing base 62 further comprises, a circular opening provided in its horizontal plate 69 intended to accommodate the refilling nozzle 31 of the container 10 so that it is concealed in the skirt 620 of the base 62 after insertion. An annular disk 68, whereof the edges 681 are lifted upwards, is fixed on the upper side of the horizontal plate 69 of the base 62 to accommodate the liquid container 10.

The housing 60 rests on the horizontal portion 42 of the support seat 40. A through-hole 45 is provided from left to right in the thickness of the horizontal portion 42 of the support seat 40, in the vicinity of the upstream edge of the horizontal portion 42. The lateral sides (left and right) of the skirt 620 of the concealing base 62 each comprise a through-hole, the base openings 62 and the support seat 40 are crossed by a rod that is locked at its ends by anti-translation rings. The rod forms for the base 62 and the support seat 40, a turn over hinge enabling the base 62, which is movable, to turn over with respect to the support seat 40 which is stationary.

During the mounting of the container 10 in its housing 60, the refilling nozzle 31 of the container 10 is introduced in the opening of the horizontal plate 69 of the concealing base 62, the lower side of the container 10 being received in the annular disk 68 with lifted edges 681, edges 681 coming in contact with the lateral side of the container 10. The container 10 extends in its length, parallel to the bottom plate 63 of the housing 60.

One then fixes the cap 61 on the container 10 by passing the push button 22 of the pump 21 in the groove 66 of the upper side 612 of the cap 61 provided for this purpose. The fixing hooks 65 of the cap 61 are then inserted successively in the openings of the bottom plate 63 of the housing 60, in the openings of the vertical portion 41 of the support seat 40 and in the openings of the locking plate 90, the container 10 being maintained to the bottom plate 63, itself maintained by the support seat 40.

In locked dispensing position, the bottom plate 63 extends parallel to the vertical portion 41 of the support seat 40, the lower edge of the bottom plate 63 pressing against the horizontal portion 42 of the support seat 40. The circumferential skirt 620 of the base 62 covers the horizontal portion 42 of the support seat 40 which is not visible from the outside.

After having now described various embodiments of the invention, its operation will be now described in further detail.

In dispensing position, the container 10 is upright. Its dispensing nozzle is oriented upwards whereas its refilling nozzle 31 is oriented downwards as depicted in FIG. 1.

A user wishing to obtain a dose of dispensing liquid 1, here liquid soap, presses from top to bottom on the push button 22 of the pump 21 to lead to the aspiration of the soap of the container 10 by the plunger of the pump 21. The soap is recuperated by the user through a dispensing opening 221 provided in the push button 22.

Using the dispenser 1 is simple and intuitive, the vertically operated pump 21 enabling a precise dosage of the liquid. On the other hand, the user cannot introduce, simply and rapidly, a foreign substance in the container 10. In fact, the cap 61 of the dispenser 1 prevents the disassembling of the pump 21 by a non authorized person, the cap 61 being locked by the locking plate 90. The non authorized user is not aware that the dispenser 1 has a refill opening 30 separate from the dispensing opening 20, since the refill opening 30 is concealed in the skirt 620 of the base 62.

The steps of refilling the dispenser 1 with liquid soap will now be described in further detail.

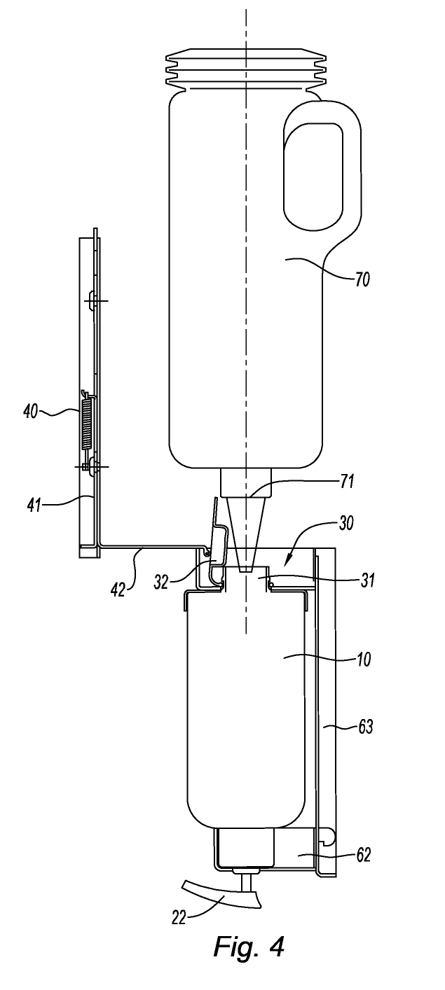

In dispensing position, the housing 60 rests on the horizontal portion 42 of the support seat 40 (FIG. 1). After unlocking, the housing 60 is turned over forwards as represented on FIG. 3 in order to be in the refilling position (FIG. 4). In the refilling position, the container 10 is inverted, its dispensing nozzle being oriented downwards whereas its refilling nozzle 31 is oriented upwards as represented on FIG. 4.

Prior to turn over, the user activates the unlocking lever 91 in order to release the fixing hooks 65 of the locking plate 90, the hooks 65 remaining fixed to the bottom plate 63 of the housing 60.

During turn over, the hinge, formed by the collaboration of the rod and the through-holes provided in the base 62 and the support seat 40, enable the housing 60 to turn with respect to the support seat 40 which remains stationary. In this example, the support seat 40 is securely fixed to a wall.

After a half-circle turn over, the lower edge of the front side of the skirt 620 comes in abutment with the lower side of the horizontal portion 42 of the support seat 40, as depicted in FIG. 4. The container 10 is maintained in inverted position with its refilling nozzle 31 oriented upwards. Because of the stop achieved by the lower edge of the front side of the skirt 620, the refilling position is stable. The refilling nozzle 31, closed by the cap 32, is thus uncovered. As for the container 10 it is, maintained in the housing 60 by the upper cap 61 which prevents it from falling under the effect of gravity.

During refilling, the cap 32, closing the refilling nozzle 31, is removed. One fills the container 10 by means of a refilling bottle 70, whereof the volume is usually higher than that of the container 10, via its dispensing funnel 71 which is introduced into the refilling nozzle 31.

The refilling operation is easy for several reasons. First of all, after turn over, the container 10 is moved away from the wall whereon the support seat 40 of the dispenser 1 is fixed, at a distance corresponding to the length of the horizontal portion 42 of the support seat 40. Thus, the container 10 is nearer to the user who can refill the container 10 without having to hold the refilling bottle 70 at arm's length. This is particularly advantageous when the dispenser 1 is, for example, mounted in a bathtub.

Then, as the dispenser 1 is maintained in a stable position, the user can use both his/her hands to hold the refilling bottle 70, the refilling thus being more precise and less subject to dirtying. Finally, even if liquid from the refilling bottle 70 falls next to the refilling nozzle 31, this liquid would be recuperated and concealed by the skirt 620 of the concealing base 62. Once the container 10 is refilled, the latter is turned back over to the dispensing position, the refilling nozzle 31 being concealed again by the concealing base 62. The external aspect of the dispenser 1 remains clean after refilling.

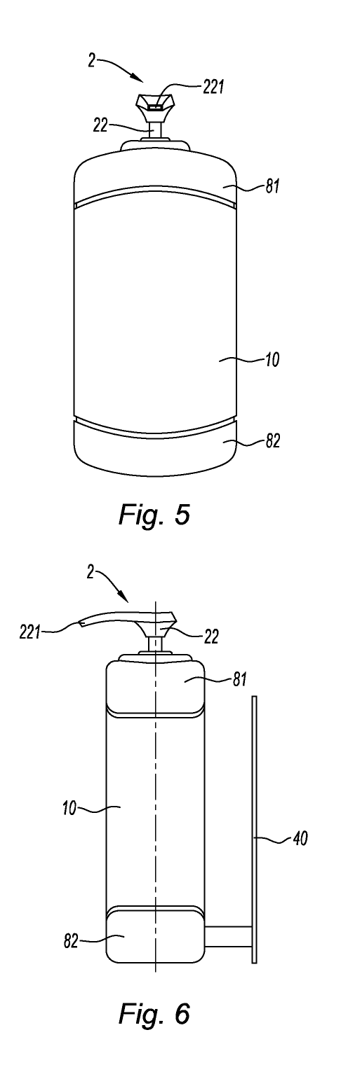

With reference to FIGS. 5 to 9, the liquid dispenser 2 may be exhibited according to a second embodiment.

This embodiment is very similar to the previous embodiment and that is why the references used for the elements of the dispenser in FIGS. 5 to 9 of identical structure or function, equivalent or similar to those of the elements of the device of FIGS. 1 to 4 are the same, in order to simplify the description. Moreover, the entirety of the description of the device in FIG. 1 is not restated, this description applying to the device of FIGS. 5 to 9 when there are no inconsistencies.

With reference to FIGS. 5 to 7, the liquid dispenser 2 comprises a protective cap 81 and a protective base 82 respectively coming to cover the base of the pump 20, to prevent its disassembly, and the refilling nozzle 31 of the container 10.

The protective cap 81 is presented in the form of a rectangular lid comprising an opening in its upper side for the passage of the upper portion of the pump 21. The dimensions of the protective cap 81 are here adapted to fit the upper portion of the container 10 whereon it is mounted. The protective cap 81 comes to encase the pump 21 from top to bottom.

With reference to FIG. 8, the protective base 82 is presented in the form of a rectangular lid comprising in its rear side an opening for the passage of the supporting arms 44 of the support seat 40. The dimensions of the protective base 82 are here adapted to fit the lower portion of the container 10 whereon it is mounted. The protective base 82 comes to encase the container 10 refilling nozzle 31 from bottom to top.

In this embodiment, the container 10 is only connected to the support seat 40 by its lower portion as opposed to the previous embodiment wherein the container was maintained by its upper portion (supporting cap 61) as well as by its lower portion (concealing base 62).

The vertical portion of the support seat 40, designated hereafter by fixing plate 41, is vertically connected to a wall by screws crossing fixing bores 52 provided in the said plate 41. Two horizontal supporting arms 44 extend forwardly, perpendicular to the fixing plate 41. The supporting arms 44 are parallel and comprise at their free end a through-hole 45. The support seat 40 further comprises a horizontal wall 46 whereof the rear edge is fixed to the fixing plate 41 and whereof the lateral sides are fixed to the upper edges of the supporting arms 44, the horizontal wall 46 only covering a part of the length of the supporting arms 44.

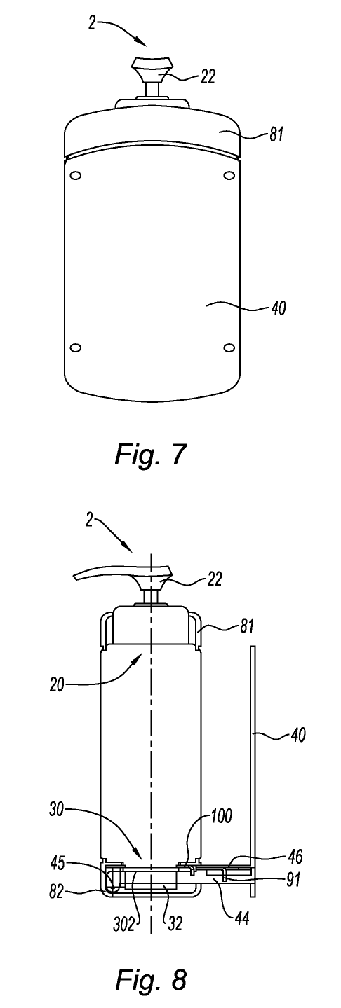

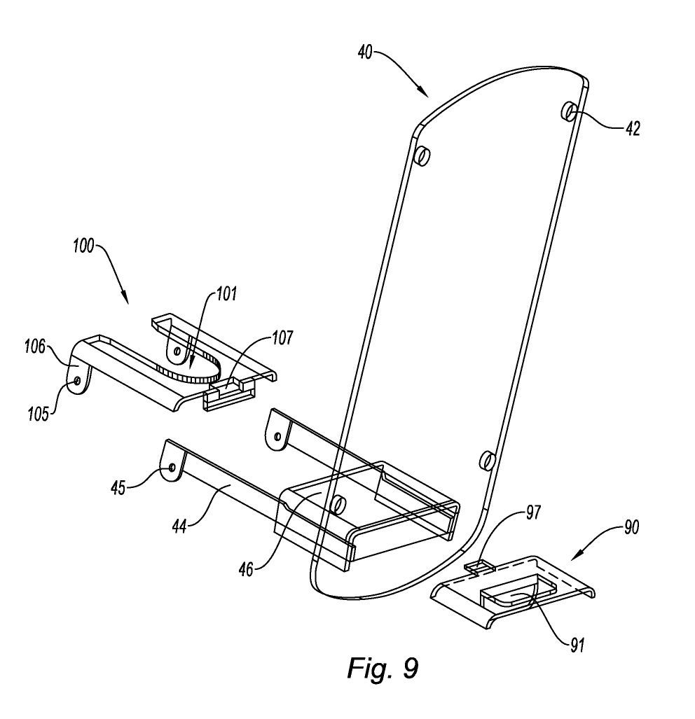

With reference to FIG. 7, the refilling nozzle 31 is maintained in a notch 101 formed in a supporting base 100 of the dispenser. The supporting base 100, represented in FIG. 9, is presented in the form of a horizontal plate, of rectangular shape, wherein is provided a notch 101 from the front edge of the plate to the vicinity of its rear edge. The supporting base 100 comprises rotary arms 106, orthogonal to the said horizontal plate whereof the supporting base 100 has the shape, provided from the front end of the lateral edges and oriented downwards. A thorough-hole 105 of rod passage is provided in each of the rotary arms 106 of the supporting base 100.

The supporting base 100 is rotatably mounted with the support seat 40 of the dispenser 2. With reference to FIG. 8, the openings 105 of the supporting base 100 and the support seat 40 are crossed by a rod which is locked at its ends by anti-translation rings. The rod forms, for the supporting base 100 and the support seat 40, a turn over hinge enabling the supporting base 100 which is movable, to turn over with respect to the support seat 40 which is stationary.

In dispensing position, the supporting base 100 rests on the supporting arms 44 of the support seat 40, the rotary arms 106 being external to the supporting arms 44 and oriented downwardly, the lower side of the supporting base 100 pressing against the upper edges of the supporting arms 44 that are not covered by the horizontal wall 46 of the support seat 40. The supporting base 100 can turn over forwardly to invert the container 10 to the refilling position.

The supporting base 100 comprises on the rear edge of its horizontal plate a locking opening 107 intended to receive a tab 97 of a locking plate 90 that is mounted between the supporting base 100 and the fixing plate 41 of the support seat 40. The locking plate 90 is here mounted on rails provided in the lateral inside surface of the supporting arms 44 of the support seat 40, the locking plate 90 sliding from front to back on the rails under the horizontal wall 46 of the support seat 40.

With reference to FIG. 9, the locking plate 90 is presented in the form of a horizontal plate, of rectangular shape, comprising on its front edge a locking tab 97, protruding forwardly, which extends in the same plane as the upper side of the locking plate 90. An unlocking lever 91 is provided in the locking plate 90, the lever 91 exhibited in the form of a vertical portion, protruding downwardly, extending parallel to the fixing plate 51, which is provided centrally in the lower side of the locking plate 90.

In dispensing position, the locking plate 90 is in abutment according to its front edge with the supporting base 100, the locking tab 97 being introduced in the locking opening 107 of the supporting base 100 to prevent the turning over of the container in the refilling position.

To turn over the container 10, the user activates the unlocking lever 91 by pushing it backwards in order to disengage the locking tab 97 from the unlocking opening 107. In an embodiment, a spring is mounted between the locking plate 90 and the vertical plate 41 of the support seat 40 in order to push the locking tab 97 into the corresponding opening 107. After unlocking, the supporting base 100 can rotationally enter with respect to the supporting arms 44.

In this example, the refilling nozzle 31 of the container 10 comprises a radial lip 302 which is inserted, from front to back, into the notch 101 of the supporting base 100. In dispensing position of the dispenser 2, the portion of the radial lip 302, which is turned towards the container 10, is in contact with the lower side of the supporting base 100. The container 10 is maintained vertically on the supporting base 100, the refilling nozzle 31 extending vertically under the supporting base 100. The protective base 82 is encased from below, from bottom to top, in order to cover the hinge as well as the refilling nozzle 31. In other words, the supporting base 100 and the protective base 82 serve to fulfill the functions of concealing the refill opening and turning over which were carried out by the concealing base 62 in the first embodiment.

The opening provided in the rear side of the protective base 82 enables the passage of the supporting arms 44 of the support seat 40 as well as the locking tab 97 of the locking plate 90. In dispensing position, the refilling nozzle 31 is not visible.

In order to refill the container 10, the protective base 82 is uncased, then the locking lever 91 is activated in order to release the supporting base 100 which turns over forward with the container 10 to become immobilized in horizontal position, the rotary arms 106 of the supporting base 100 thus being oriented upwardly. The container 10 is inverted, the radial lip 302 maintaining the container 10 secured to the supporting base. The refilling nozzle 31 is oriented upwardly. All that needs to be done is remove the cap 32 of the refilling nozzle 31 in order to fill the container 10.

The dispenser 1, 2 has been described as fixed to a wall, but the dispenser may also be fixed to a horizontal surface by fixing the support seat 40 on the surface.

As described, a rod passing through openings provided in the support seat 40 as well as in the housing 60 form a turn over hinge. This turn over hinge could be implemented by other means, such as a pivot joint formed between the two elements. Thus, the pivot joint may be achieved by two independent rods, each rod crossing an opening of the support seat 40 and an opening of the housing 60/of the supporting base 100.

The pivot joint could be formed in an orthogonal direction to the wall whereon is fixed the support seat 40 so that the container may turn in a clockwise/anticlockwise direction between its dispensing and refilling positions. For example, the pivot joint may be formed between the bottom plate 63 of the housing and the fixing plate 41 of the support seat 40.

1. A manually operated liquid dispenser, having a dispensing position and a refilling position, comprising
a liquid container comprising
a dispensing opening through which the liquid is discharged from the container in the dispensing position of the dispenser
and
a refill opening separate from the dispensing opening through which the liquid is introduced in the refilling position of the dispenser and
a supporting structure which supports the liquid container in such a way as to conceal the refill opening in the dispensing position and to uncover the refill opening in the refilling position,
the dispenser characterized in that the supporting structure of the container comprises means for inverting the container which are designed to hold the container upright in the dispensing position and inverted in the refilling position.

2. The dispenser according to claim 1, wherein the dispensing opening and the refill opening are provided at the two opposing ends of the liquid container.

3. The dispenser according to claim 1, wherein the supporting structure comprises a support seat, to be fixedly maintained, and a housing in which the liquid container is accommodated, the housing being rotatably mounted with respect to the support seat.

4. The dispenser according to claim 3, wherein the support seat comprises wall fixation means.

5. The dispenser according to claim 1, 4, wherein the housing of the liquid container comprises a base for concealing the refill opening.

6. The dispenser according to claim 1 wherein the liquid container comprises a refilling nozzle which is introduced into an opening provided in the concealing base.

7. The dispenser according to claim 3, comprising a locking plate arranged to lock/unlock the position of the housing with respect to the support seat.

8. The dispenser according to claim 5, wherein a supporting cap, arranged to maintain the container in the refilling position, is provided to the upper portion of the housing, the concealing base being provided in the lower portion of the housing of container.
